(19) United States
(12) Patent Application Publication
(10) Pub. No.: US 2026/0051707 A1
(43) Pub. Date: Feb. 19, 2026

(54) Self-Locking Structure for Bulkhead Connector and Bulkhead Connector

(71) Applicants: Tyco Electronics (Suzhou) Ltd., Suzhou City (CN); Tyco Electronics (Shanghai) Co., Ltd., Shanghai (CN)

(72) Inventors: Feng (Charles) Wan, Shanghai (CN); Shenji (David) Zong, Suzhou (CN); Jinfeng (Jeff) Shang, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/298,365

(22) Filed: Aug. 13, 2025

(30) Foreign Application Priority Data
Aug. 13, 2024 (CN) 202411112383.1

(51) Int. Cl. H01R 13/74; H01R 13/50

(52) U.S. Cl. CPC H01R 13/746; H01R 13/50

(57) ABSTRACT

A bulkhead connector comprises a connector housing, a nut member and a self-locking structure. The nut member is removably fitted to the connector housing to secure the bulkhead connector to a target plate body. An outer surface of the connector housing is formed with an outer thread, and an inner surface of the nut member is formed with an inner thread. The self-locking structure includes a groove formed in the outer surface of the connector housing, and an elastic locking element arranged on the nut member. Upon a thread fit between the inner thread of the nut member and the outer thread of the connector housing, at least a portion of the elastic locking element engages with the groove to form a self-locking of the thread fit.

### CROSS-REFERENCE TO RELATED APPLICATION

This application claims the benefit of Chinese Patent Applications No. CN 202411112383.1 filed on Aug. 13, 2024 in the China National Intellectual Property Administration, the whole disclosure of which are incorporated herein by reference.

### FIELD OF THE DISCLOSURE

The disclosure relates to the technical field of electrical connectors, and in particular, to a self-locking structure for a bulkhead connector and a bulkhead connector.

### BACKGROUND OF THE INVENTION

A bulkhead connector is adapted to electrical connection inside and outside a cylinder body of, for example, a heavy machinery vehicle. At present, there are two common methods for fixation of the bulkhead connector.

One method is a threaded connection. An outer surface of a connector housing is provided with an outer thread, an inner surface of a nut member for fixation is provided with an inner thread, and the connector is secured to a plate of the cylinder body by a threaded connection between the inner thread of the nut member and the outer thread of the connector housing after the connector passes through the cylinder body plate. The advantage of this threaded connection is that it can be adapted to the cylinder body plates with different thicknesses, and it is simple to operate and easy to disassemble; however, the disadvantage is that the threaded connection is easy to loosen when it is in a vibration environment for a long time, thereby affecting the fixation and sealing performances.

Another method is a fixed ring buckle connection. An outer surface of a connector housing is provided with a number of bump(s), an inner surface of a fixing ring is correspondingly provided with elastic buckle(s). After the connector passes through a plate of the cylinder body, the elastic buckle is elastically compressed when it passes through the bump and the elastic buckle rebounds and abuts against the bump after passing over the bump during the fixing ring is sleeved on the connector housing, so that the buckle connection between the connector housing and the fixing ring is realized, thereby securing the connector on the cylinder body plate. The advantage of this type of fixed ring buckle connection is that it can maintain a good fixation effect even in a vibration environment for a long time; however, the disadvantage is that since both the position of the bump on the connector housing and the position of the elastic buckle on the fixed ring are fixed, it can only be adapted to the cylinder body plate with a specific thickness and cannot be flexibly adapted to the cylinder body plates with different thicknesses. In addition, this type of fixed ring buckle connection has the disadvantage of being difficult to disassemble.

Thus, an improved fixed method adapted to the bulkhead connector is needed to solve the problems of the existing bulkhead connector being easy to loosen in the vibrating environment for a long time and of the difficulty in adapting to different types of plate thicknesses in the art.

### SUMMARY OF THE INVENTION

According to an embodiment of the present disclosure, a bulkhead connector comprises a connector housing, a nut member and a self-locking structure. The nut member is removably fitted to the connector housing to secure the bulkhead connector to a target plate body. An outer surface of the connector housing is formed with an outer thread, and an inner surface of the nut member is formed with an inner thread. The self-locking structure includes a groove formed in the outer surface of the connector housing, and an elastic locking element arranged on the nut member. Upon a thread fit between the inner thread of the nut member and the outer thread of the connector housing, at least a portion of the elastic locking element engages with the groove to form a self-locking of the thread fit.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a schematic view showing a structure of a bulkhead connector and a nut member assembled together according to an exemplary embodiment of the present disclosure;

FIG. 2 is a schematic perspective view showing a structure of the nut member according to the exemplary embodiment of the present disclosure;

FIG. 3 is a schematic perspective view showing a structure of a connector housing of the bulkhead connector according to the exemplary embodiment of the present disclosure;

FIG. 4 is a schematic sectional view of FIG. 1, showing that a self-locking structure is in a locked state;

FIG. 5 is an enlarged schematic view of a structure of a portion selected by a rectangular dashed box in FIG. 4;

FIG. 6 is a schematic sectional view of FIG. 1, showing that the self-locking structure is in an unlocked state;

FIG. 7 is an enlarged schematic view of a structure of a portion selected by a rectangular dashed box in FIG. 6;

FIG. 8 is a schematic perspective view showing a structure of a nut member according to a further exemplary embodiment of the present disclosure;

FIG. 9 is a schematic sectional view of FIG. 8, showing that a self-locking structure is in a locked state; and

FIG. 10 is a schematic sectional view s of FIG. 8, showing that the self-locking structure is in an unlocked state.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a self-locking structure for a bulkhead connector is provided. The bulkhead connector includes a connector housing and a nut member being removably fitted to the connector housing to secure the bulkhead connector to a target plate body, wherein, an outer surface of the connector housing is formed with an outer thread, and an inner surface of the nut member is formed with an inner thread; wherein, the outer surface of the connector housing is provided with a groove, and the nut member is provided with an elastic locker. Upon a thread fit between the inner thread of the nut member and the outer thread of the connector housing, at least a portion of the elastic locker goes into the groove, to form a self-locking of the thread fit. According to another general technical concept of the present disclosure, there is further provided a bulkhead connector including the aforementioned self-locking structure.

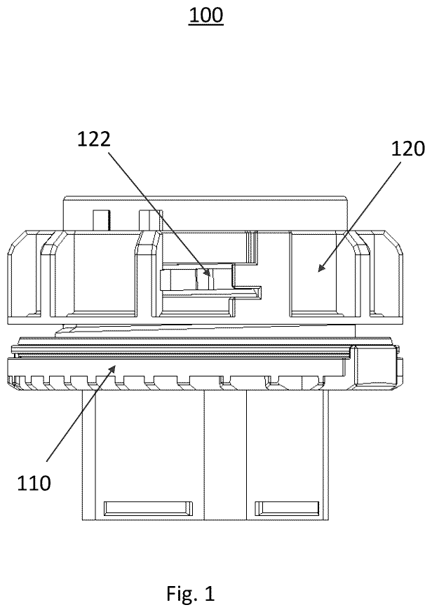

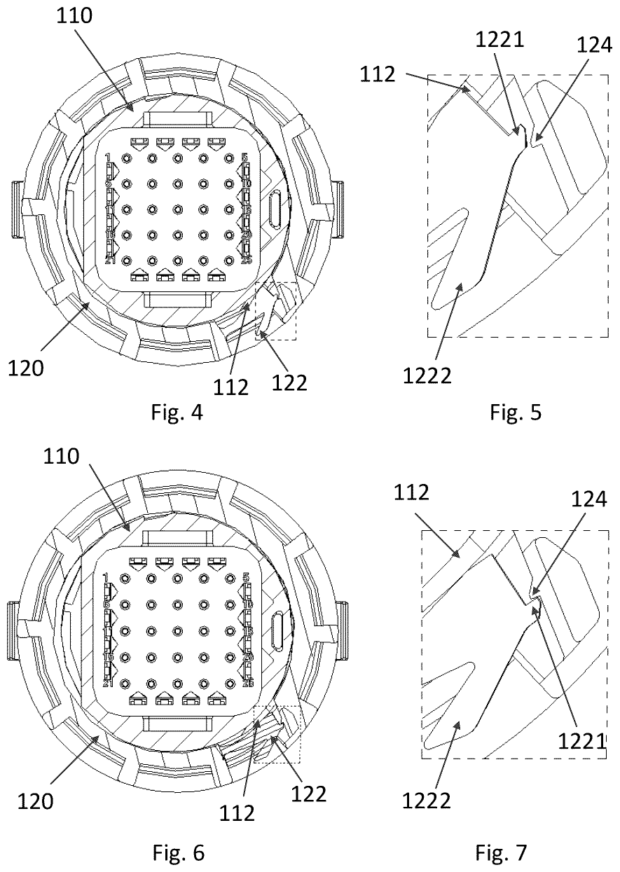

Referring to FIGS. 1-10, according to an embodiment of the present disclosure, there is provided a self-locking structure for a bulkhead connector 100. The bulkhead connector 100 mainly includes a connector housing 110, a conductive terminal and a terminal seat (see, for example, FIGS. 4, 6, 9 and 10, unlabeled) provided in the connector housing 110, and other parts. The bulkhead connector 100 further includes a nut member 120. The nut member 120 is removably fitted to the connector housing 110 to secure the bulkhead connector 100 to a target plate body (e.g., a cylinder body plate of a heavy machinery vehicle, not shown). According to the present disclosure, as shown in FIGS. 1 to 7, an outer surface of the connector housing 110 is formed with an outer thread 111, an inner surface of the nut member 120 is formed with an inner thread 121; the outer surface of the connector housing 110 is provided with a groove 112, and the nut member 120 is provided with an elastic locker 122. Upon a thread fit between the inner thread 121 of the nut member 120 and the outer thread 111 of the connector housing 110, at least a portion of the elastic locker 122 goes into the groove 112, to form a self-locking of the thread fit between the nut member 120 and the connector housing 110. According to the design concept of the present disclosure, the elastic locker 122 is provided inside with the nut member 120, and the elastic locker 122 can be elastically deformed and finally go into the groove 112 predefined in the outer surface of the connector housing 110 during the process of tightening the nut member 120 to the connector housing 110, thereby forming the self-locking of the thread fit.

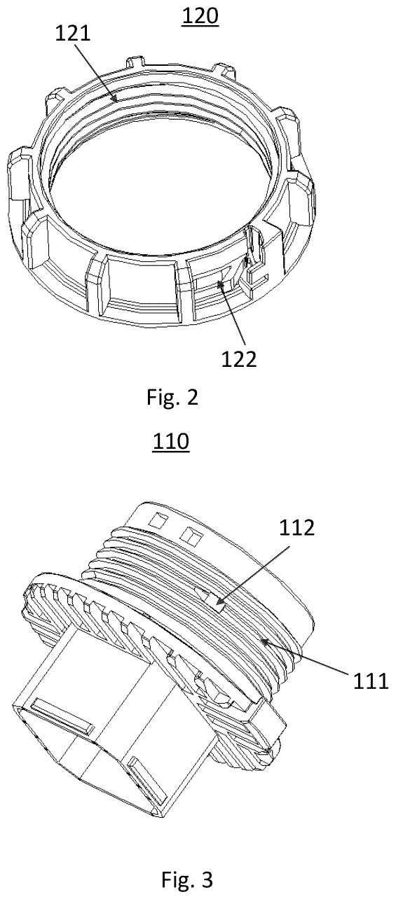

According to the exemplary embodiments of the present disclosure, as shown in FIGS. 2 and 3, specifically, the groove 112 is provided in a region of the outer surface of the connector housing 110 where the outer thread 111 is formed; and the elastic locker 122 is provided in a region of the inner surface of the nut member 120 where the inner thread 121 is formed.

According to the exemplary embodiments of the present disclosure, as shown in FIG. 2 and FIGS. 4-7, the elastic locker is specifically an elastic cantilever 122, and the elastic cantilever 122 extends inwardly from the inner surface of the nut member 120. That is, at least a portion (e.g., a cantilever end) of the elastic cantilever 122 is closer to a central axis of the nut member 120 than the inner surface of the nut member 120 in a radial direction of the nut member 120 in a naturally unstressed state. In this way, during the tightening of the nut member 120 to the connector housing 110, the at least a portion (e.g., the cantilever end) of the elastic cantilever 122 elastically abuts against the outer thread of the connector housing 110 until it meets the groove 112 formed in the outer surface of the connector housing 110, and the at least a portion (e.g., the cantilever end) of the elastic cantilever 122 goes into the groove 112 under the action of its elastic force itself, thereby forming the self-locking of the thread fit. According to the design concept of the present disclosure, the groove 112 matches the at least a portion of the elastic cantilever 122 of the nut member 120 in shape and/or size, ensuring that the at least a portion of the elastic cantilever 122 can be smoothly inserted into the groove 112 during the tightening.

According to the exemplary embodiments of the present disclosure, as shown in FIG. 2 and FIGS. 4-7 (especially, FIG. 5 and FIG. 7), the nut member 120 is also provided with a stopping block 124, wherein, upon the abutment of a cantilever end protrusion 1221 of the elastic cantilever 122 against the stopping block 124, the at least a portion of the elastic cantilever 122 is lifted away from the groove 112 to release the self-locking of the thread fit. According to the exemplary embodiments of the present disclosure, as shown in FIG. 2 and FIGS. 4-7, the elastic cantilever 122 also includes an operating portion 1222, wherein, upon toggling the operating portion 1222, the cantilever end protrusion 1221 of the elastic cantilever 122 can be disengaged from the abutment with the stopping block 124. Specifically, when it is necessary to release the self-locking of the thread fit, it only needs to simple toggle the operating portion 1222 of the elastic cantilever 122 with a finger, so that the at least a portion (e.g., the cantilever end) of the elastic cantilever 122 is lifted away from the groove 112, and then the cantilever end protrusion 1221 of the elastic cantilever 122 abuts against the stopping block 124, at this time, the elastic cantilever 122 may be kept lifted out of the groove 112, thereby releasing the self-locking of the thread fit. In this way, the nut member 120 can be easily unscrewed from the connector housing 110 later.

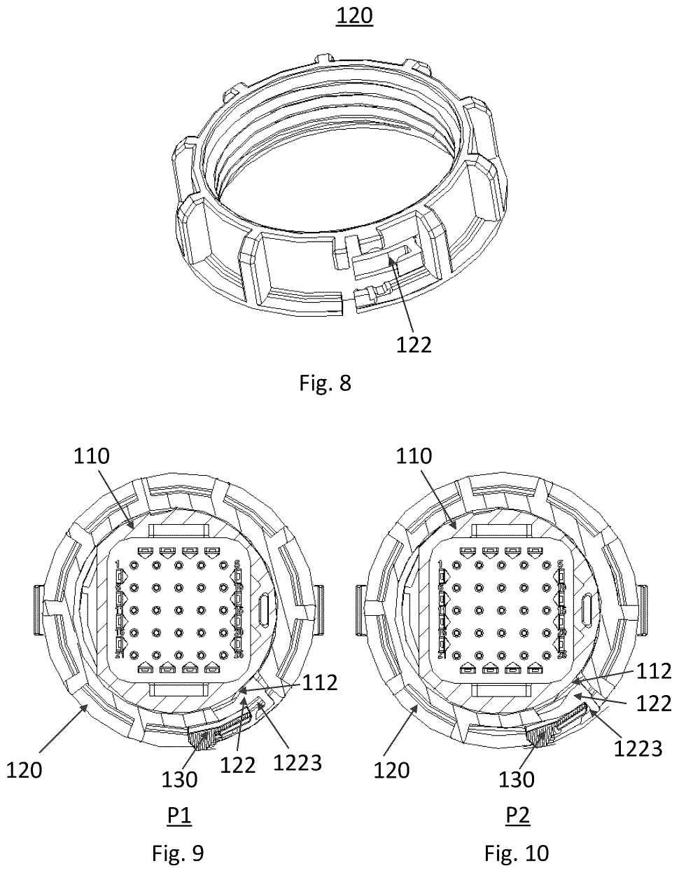

According to a further embodiment of the present disclosure, as shown in FIGS. 8-10, the self-locking structure also includes a sliding unlocking member 130, which is slidably provided on the outer surface of the nut member 120 and is configured to be able to slide between a first position P1 and a second position P2 along the outer surface of the nut member 120. As shown in FIG. 9, when the sliding unlocking member 130 slides to the first position P1, the sliding unlocking member 130 does not act on the at least a portion of the elastic cantilever 122 located in the groove 112, and at this time, the at least a portion (e.g., the cantilever end) of the elastic cantilever 122 located in the groove 112 goes into the groove 112 under the action of its elastic force itself. As shown in FIG. 10, when the sliding unlocking member 130 slides to the second position P2, the sliding unlocking member 130 lifts the at least a portion (e.g., the cantilever end) of the elastic cantilever 122 away from the groove 112, thereby releasing the self-locking of the thread fit. More specifically, as shown in FIGS. 8 to 10, the elastic cantilever 122 also includes a receiving portion 1223, wherein when the sliding unlocking member 130 slides to the second position P2, the sliding unlocking member 130 at least partially goes into the receiving portion 1223 to keep the at least a portion of the elastic cantilever 122 lifted out of the groove 112, thereby releasing the self-locking of the thread fit. More specifically, as shown in FIGS. 8 to 10, the sliding unlocking member 130 is closer to the cantilever end protrusion of the elastic cantilever 122 when it is in the second position P2 than when it is in the first position P1. With the provision of the sliding unlocking member 130, the operator can complete the self-locking of the thread fit and release the self-locking of the thread fit with one hand.

In addition, although not shown in the figures, in some embodiments of the present disclosure, the outer surface of the connector housing 110 is provided with a plurality of grooves 112, the plurality of grooves 112 being provided independently of each other along an axial direction of the connector housing 110. According to a thickness of the cylinder body plate, the elastic locker 122 can be elastically deformed and finally goes into one groove 112 corresponding to the thickness of the cylinder body plate during the process of tightening the nut member 120 to the connector housing 110, thereby forming the self-locking of the thread fit. In this way, the same nut member can be adapted to cylinder body plates with different thicknesses.

According to another aspect of the present disclosure, there is provided a bulkhead connector 100. The bulkhead connector 100 includes a self-locking structure according to any one of the aforementioned embodiments.

In the self-locking structure for the bulkhead connector and the bulkhead connector provided by the various foregoing exemplary embodiments of the present disclosure, a releasable self-locking structure is provided on both the connector housing and the nut member on the basis of the existing threaded connection, so that the threaded connection between the connector housing and the nut member is not easy to loosen when the bulkhead connector is in the vibration environment for a long time, which is beneficial to the fixing and sealing of the bulkhead connector; at the same time, the same nut member can be adapted to cylinder body plates with different thicknesses. In addition, the unlocking operation of the self-locking structure is simple and convenient.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the preferred embodiments of the present disclosure by way of example, and should not be construed as limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “include” or “include” does not exclude other elements or steps, and the word “a” or “an” does not exclude more than a plurality. In addition, any reference numerals in the claims should not be interpreted as the limitation to the scope of the present disclosure.

1. A self-locking structure for a bulkhead connector, the bulkhead connector comprising a connector housing and a nut member being removably fitted to the connector housing to secure the bulkhead connector to a target plate body, wherein, an outer surface of the connector housing is formed with an outer thread, and an inner surface of the nut member is formed with an inner thread, wherein:
the outer surface of the connector housing is provided with a groove, and the nut member is provided with an elastic locker; and
upon a thread fit between the inner thread of the nut member and the outer thread of the connector housing, at least a portion of the elastic locker goes into the groove, to form a self-locking of the thread fit.

2. The self-locking structure according to claim 1, wherein:
the groove is provided in a region of the outer surface of the connector housing where the outer thread is formed; and
the elastic locker is provided in a region of the inner surface of the nut member where the inner thread is formed.

3. The self-locking structure according to claim 2, wherein the elastic locker is an elastic cantilever that extends inwardly from the inner surface of the nut member.

4. The self-locking structure according to claim 3, wherein:
the nut member is further provided with a stopping block; and
upon abutment of a cantilever end protrusion of the elastic cantilever against the stopping block, the at least a portion of the elastic cantilever is lifted away from the groove to release the self-locking of the thread fit.

5. The self-locking structure according to claim 3, wherein the elastic cantilever further comprises an operating portion, upon toggling the operating portion, the cantilever end protrusion of the elastic cantilever is able to be disengaged from the abutment with the stopping block.

6. The self-locking structure according to claim 3, wherein, the self-locking structure further comprises a sliding unlocking member being slidably provided on an outer surface of the nut member and being configured to slide between a first position and a second position along the outer surface of the nut member, wherein, when the sliding unlocking member slides to the first position, the sliding unlocking member does not act on the at least a portion of the elastic cantilever located in the groove; and when the sliding unlocking member slides to the second position, the sliding unlocking member lifts the at least a portion of the elastic cantilever away from the groove, thereby releasing the self-locking of the thread fit.

7. The self-locking structure according to claim 6, wherein the elastic cantilever further comprises a receiving portion, when the sliding unlocking member slides to the second position, the sliding unlocking member at least partially goes into the receiving portion to lift the at least a portion of the elastic cantilever away from the groove.

8. The self-locking structure according to claim 6, wherein the sliding unlocking member is closer to the cantilever end protrusion of the elastic cantilever when being in the second position than when being in the first position.

9. The self-locking structure according to claim 1, wherein the outer surface of the connector housing is provided with a plurality of grooves, the plurality of grooves being provided independently of each other along an axial direction of the connector housing.

10. A bulkhead connector, comprising:
a connector housing;
a nut member being removably fitted to the connector housing to secure the bulkhead connector to a target plate body, wherein an outer surface of the connector housing is formed with an outer thread, and an inner surface of the nut member is formed with an inner thread; and
a self-locking structure, including:
a groove formed in the outer surface of the connector housing; and
an elastic locking element arranged on the nut member, upon a thread fit between the inner thread of the nut member and the outer thread of the connector housing, at least a portion of the elastic locking element engages with the groove to form a self-locking of the thread fit.

11. The bulkhead connector according to claim 10, wherein the groove is provided in a region of the outer surface of the connector housing where the outer thread is formed.

12. The bulkhead connector according to claim 11, wherein the elastic locker is provided in a region of the inner surface of the nut member where the inner thread is formed.

13. The bulkhead connector according to claim 12, wherein the elastic locker is an elastic cantilever that extends inwardly from the inner surface of the nut member.

14. The bulkhead connector according to claim 13, wherein the nut member is further provided with a stopping block.

15. The bulkhead connector according to claim 14, wherein upon abutment of a cantilever end protrusion of the elastic cantilever against the stopping block, the at least a portion of the elastic cantilever is lifted away from the groove to release the self-locking of the thread fit.

16. The bulkhead connector according to claim 13, wherein the elastic cantilever further comprises an operating portion, upon toggling the operating portion, the cantilever end protrusion of the elastic cantilever is able to be disengaged from the abutment with the stopping block.

17. The bulkhead connector according to claim 13, wherein, the self-locking structure further comprises a sliding unlocking member being slidably provided on an outer surface of the nut member and being configured to slide between a first position and a second position along the outer surface of the nut member, wherein:
when the sliding unlocking member slides to the first position, the sliding unlocking member does not act on the at least a portion of the elastic cantilever located in the groove; and
when the sliding unlocking member slides to the second position, the sliding unlocking member lifts the at least a portion of the elastic cantilever away from the groove, thereby releasing the self-locking of the thread fit.

18. The bulkhead connector according to claim 17, wherein the elastic cantilever further comprises a receiving portion, when the sliding unlocking member slides to the second position, the sliding unlocking member at least partially goes into the receiving portion to lift the at least a portion of the elastic cantilever away from the groove.

19. The bulkhead connector according to claim 17, wherein the sliding unlocking member is closer to the cantilever end protrusion of the elastic cantilever when being in the second position than when being in the first position.

20. The bulkhead connector according to claim 10, wherein the outer surface of the connector housing is provided with a plurality of grooves, the plurality of grooves being provided independently of each other along an axial direction of the connector housing.
